(19) United States
(12) Patent Application Publication
(10) Pub. No.: US 2002/0135562 A1
(43) Pub. Date: Sep. 26, 2002

(54) Mouse housing with integrally formed holding portion and key portion

(75) Inventor: Chang-Chih Wu, Taipei (TW)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Primax Electronics Ltd.

(21) Appl. No.: 09/815,211

(22) Filed: Mar. 22, 2001

(51) Int. Cl. G09G 5/08

(52) U.S. Cl. 345/163

(57) ABSTRACT

A housing structure with integrally formed holding portion and key portion is disclosed. The housing structure includes a main body made of a flexible material; a key portion arranged on and integrally formed with the main body to be depressed to enter a command therethrough; and an elongated recess arranged as an interface between the main body and the key portion for allowing the key portion to be bent down relative to the main body to enter the command. Owing to the integration of the entire housing structure, the manufacturing and assembling of the housing are relatively easy, and the cost is relatively low. Moreover, the housing can be made smooth and beautiful.

### FIELD OF THE INVENTION

The present invention relates to a housing structure, and more particularly to a housing structure of an input device such as a mouse or a track ball, which enters a command by pressing a key.

### BACKGROUND OF THE INVENTION

A mouse device has so far been a most common input device for a personal computer. Please refer to FIG. 1 which is a schematic diagram showing the appearance of a conventional mouse device. As shown, the mouse housing includes key portions 11 and 12 for giving a command therethrough, and a main body 13 for supporting the mouse device and resting thereon a user's hand. In order to allow either the key portion 11 or 12 to be depressed to enter the user's command, the key portions 11 and 12 and the main body 13 are made to be independent from one another. In other words, three separate molding procedures are required to manufacture the three parts, and an additional assembling procedure is required to combine the three parts to form the entire housing structure. Especially for mouse devices having advanced functions, e.g. meeting the requirements on the developing Graphic User Interface (GUI), more control keys for various operations are required. Therefore, the manufacturing and assembling processes are even more complicated, and the cost is even higher.

### SUMMARY OF THE INVENTION

Therefore, an object of the present invention is to provide a housing structure of an input device, which has integrally formed but independently operated key and holding portions.

According to a first aspect of the present invention, a housing structure of an input device includes a main body made of a flexible material; a key portion arranged on and integrally formed with the main body to be depressed to enter a command therethrough; and a first elongated recess arranged as an interface between the main body and the key portion for allowing the key portion to be bent down relative to the main body to enter the command.

The main body may be provided for resting thereon a user's hand, and alternatively, for supporting the input device.

Preferably, the flexible material is plastic, and more particularly transparent plastic.

Preferably, the key portion includes a plurality of control keys. A selected one of the plurality of control keys is independently bent down to depress a corresponding key switch thereunder so as to enter the command.

For the key portion including two control keys, the two control keys are structurally separated from each other for allowing either one of the control keys to be independently depressed to enter the command. In this case, a third axis input module can be mounted between the two control keys. Alternatively, a second elongated recess is arranged as an interface between the two control keys for allowing either one of the control keys to be independently depressed to enter the command.

Preferably, the first and/or the second elongated recess are arranged on an internal surface of the housing of the input device.

Preferably, the housing structure further includes a third elongated recess forming a specific pattern together with the first and second elongated recesses.

According to a second aspect of the present invention, a key structure for entering a command by a depressing operation includes a main body made of a flexible material; a key portion arranged on and integrally formed with the main body to be exerted thereon the depressing operation; and a first weaken portion arranged as an interface between the main body and the key portion, and having a thickness less than respective thickness of said main body and said key portion for allowing the key portion to be bent down relative to the main body in response to the depressing operation to depress a key switch thereunder so as to enter the command.

Preferably, the key structure is provided for an input device such as a mouse device or a track ball device.

Preferably, the main body is made of a transparent plastic.

Preferably, the key portion includes a plurality of control keys which are independently bent down by being separated by a space or a second weaken portion for allowing the control keys to be independently depressed to enter the command.

### BRIEF DESCRIPTION OF THE DRAWINGS

The present invention may best be understood through the following description with reference to the accompanying drawings, in which:

FIG. 1 is a schematic diagram showing the appearance of a conventional mouse device;

FIG. 2A is a schematic diagram showing the appearance of a first embodiment of a mouse device according to the present invention;

FIG. 2B is a cross-sectional view of the mouse device of FIG. 2A;

FIG. 3 is a schematic diagram showing a second embodiment of a mouse device according to the present invention;

FIG. 4 is a schematic top plane view of a third embodiment of a mouse device according to the present invention;

FIG. 5A is a schematic top plane view of a fourth embodiment of a mouse device according to the present invention; and

FIG. 5B is a cross-sectional view of the mouse device of FIG. 5A.

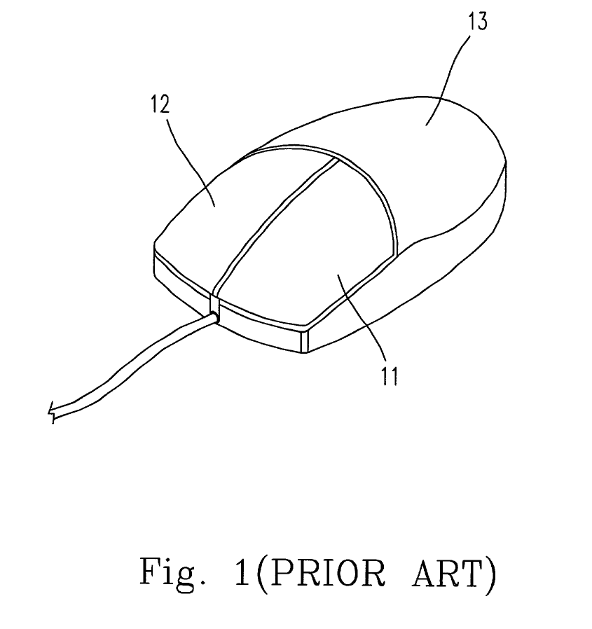

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

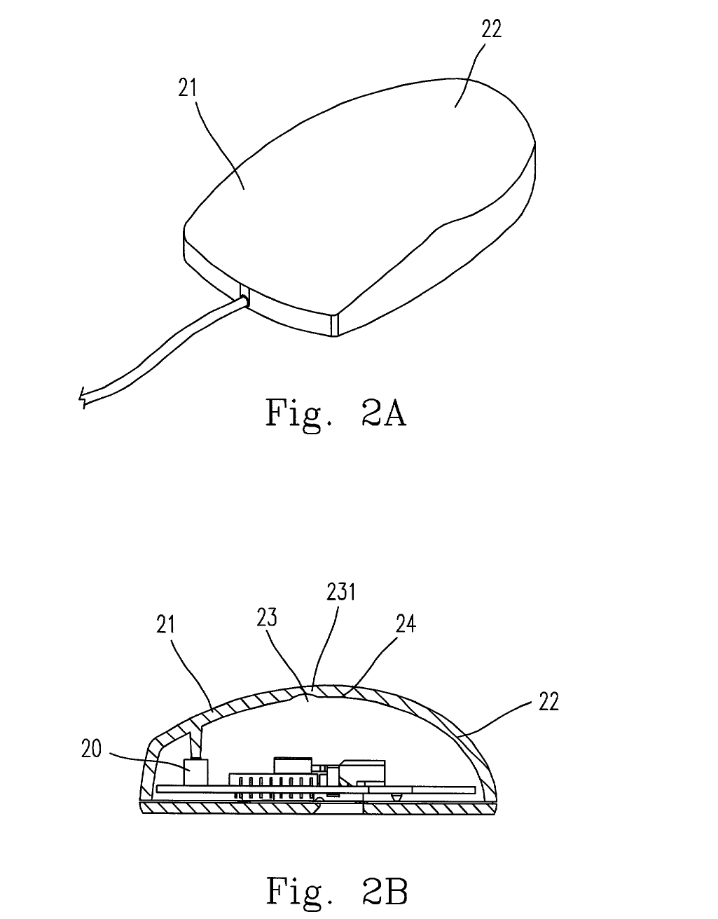

Please refer to FIG. 2A which is a schematic diagram showing the appearance of a mouse device according to the present invention. The mouse housing includes a key portion 21 for giving a command therethrough, and a main body 22 for supporting the mouse device and resting thereon a user's hand, wherein the key portion 21 and the main body 22 are integrally formed of a flexible material, e.g. plastic. As shown, there is no gap between the key portion 21 and the main body 22, so the housing surface can be made to be smooth. Further, owing to the integration of the entire housing structure, the manufacturing process is simplified, and the assembling process of the housing can be omitted. Accordingly, the cost can be reduced.

In order to allow the key portion 21 to be depressed to enter the command, an elongated recess 23 is provided on the inner surface 24 of the mouse housing between the key portion 21 and the main body 22, as shown in FIG. 2B, to weaken a portion of the housing. When a user exerts a depressing operation on the key portion 21, the key portion 21 will be able to be bent down relative to the main body 22 to depress the key switch 20 owing to the presence of the weaken and flexible part 231, thereby entering the command.

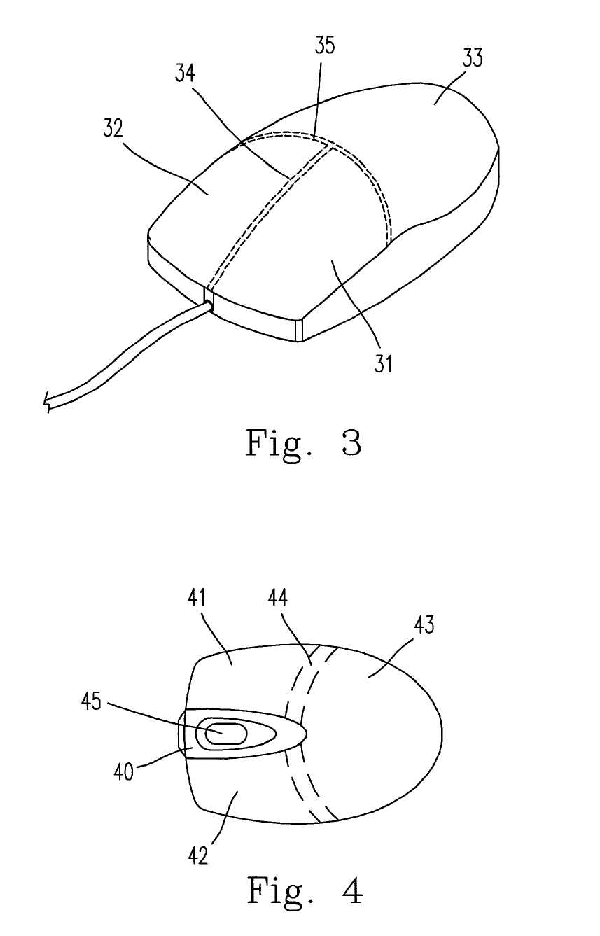

In another embodiment shown in FIG. 3, the key portion includes two control keys 31 and 32 which are interfaced by an elongated recess 34 provided in the inner surface of the mouse housing. The presence of the elongated recess 34 allows the two control keys 31 and 32 to be independently depressed and bent down. Further, between the key portion and the main body 33, another elongated recess 35 functioning as the one 23 in Big. 2B is provided.

In another embodiment shown in FIG. 4, the key portion includes two control keys 41 and 42 which are separated by an opening 40. Also, an elongated recess 44 is arranged between the key portion and the main body 43 so that the two control keys 41 and 42 can be independently depressed and bent down to enter the command, as mentioned above. In the opening, a third axial input module 45 such as a roller key is optionally arranged for scrolling the screen up/down, zooming in/out, or any other defined functions.

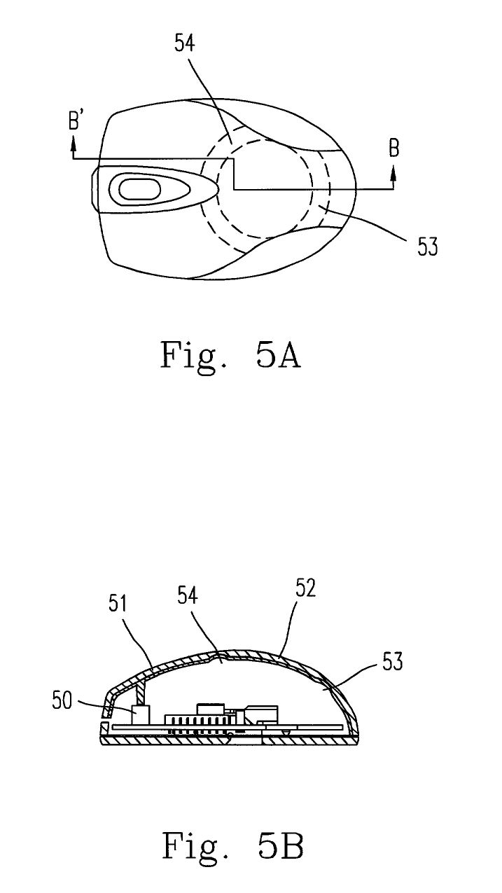

If necessary, one or more additional elongated recesses can be provided for creating a specific pattern, e.g. a company logo or a decorative shape. When a transparent flexible material is used to form the mouse housing, the specific pattern constituted by the elongated recesses can be seen. The style and position of the pattern may vary, depending on the design of the mouse device, as long as the purpose of allowing the key portion to be depressed to complete the input of the command can be achieved. For example, FIGS. 5A and 5B show a housing structure having a non-functional recess part 54 forming a decorative circle together with a functional recess part 55 wherein FIG. 5B is a cross-sectional view taken along the line B-B′. When a user exerts a depressing operation on the key portion 51, the key portion 51 will be able to be bent down relative to the main body 52 to depress the key switch 50 owing to the presence of the elongated recess 54 to weaken that part of the housing, thereby entering the command.

By providing the elongated recess(es) on the inner surface of the mouse housing, the outer housing surface can be made smooth for holding. The feature, however, is not essential for the present invention. The elongated recess(es) can also be provided on the outer surface of the mouse housing. It exhibits an advantage that the pattern can still be seen even if the housing is not transparent.

On the other hand, the application of the present invention is not limited to a mouse device. The present invention can be easily applied to any other input device such as a track ball device or any other key structure for entering a command by a depressing operation by those skilled in the art according to the disclosure as above.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A housing structure of an input device, comprising:
a main body made of a flexible material;
a key portion arranged on and integrally formed with said main body to be depressed to enter a command therethrough; and
a first elongated recess arranged as an interface between said main body and said key portion for allowing said key portion to be bent down relative to said main body to enter said command.

2. The housing structure according to claim 1 wherein said main body is provided for resting thereon a user's hand.

3. The housing structure according to claim 1 wherein said main body is provided for supporting said input device.

4. The housing structure according to claim 1 wherein said flexible material is plastic.

5. The housing structure according to claim 1 wherein said flexible material is transparent plastic.

6. The housing structure according to claim 1 wherein said key portion includes a plurality of control keys.

7. The housing structure according to claim 6 wherein a selected one of said plurality of control keys is independently bent down to depress a corresponding key switch thereunder so as to enter said command.

8. The housing structure according to claim 1 wherein said key portion includes two control keys.

9. The housing structure according to claim 8 wherein said two control keys are structurally separated from each other for allowing either one of said control keys to be independently depressed to enter said command.

10. The housing structure according to claim 9 wherein a third axis input module is mounted between said two control keys.

11. The housing structure according to claim 8 further comprising a second elongated recess arranged as an interface between said two control keys for allowing either one of said control keys to be independently depressed to enter said command.

12. The housing structure according to claim 11 wherein said second elongated recess is arranged on an internal surface of the housing of said input device.

13. The housing structure according to claim 12 further comprising a third elongated recess for forming a specific pattern together with said first and second elongated recesses.

14. The housing structure according to claim 1 wherein said first elongated recess is arranged on an internal surface of the housing of said input device.

15. A key structure for entering a command by a depressing operation, comprising:
a main body made of a flexible material;
a key portion arranged on and integrally formed with said main body to be exerted thereon said depressing operation; and
a first weaken portion arranged as an interface between said main body and said key portion, and having a thickness less than respective thickness of said main body and key portion for allowing said key portion to be bent down relative to said main body in response to said depressing operation to depress a key switch thereunder so as to enter said command.

16. The key structure according to claim 15 being provided for an input device.

17. The key structure according to claim 15 wherein said flexible material is plastic.

18. The key structure according to claim 15 wherein said flexible material is transparent.

19. The key structure according to claim 15 wherein said key portion includes a plurality of control keys which are independently bent down.

20. The key structure according to claim 19 wherein said plurality of control keys are structurally separated from each other for allowing said control keys to be independently depressed to enter said command.

21. The key structure according to claim 19 wherein said plurality of control keys are separated from each other by a second weaken portion for allowing said control keys to be independently depressed to enter said command.
